(19) United States
(12) Patent Application Publication
(10) Pub. No.: US 2022/0154501 A1
(43) Pub. Date: May 19, 2022

(54) HANDS-FREE DOOR LATCH

(71) Applicant: Newfangled Products, LLC, Joplin, MO (US)

(72) Inventors: Kevin Lee Johnson, Webb City, MO (US); Megan Louise Crozier, Joplin, MO (US); Dane DeMasters Gardner, Carl Junction, MO (US); Andrew Glen Hightower, Granby, MO (US)

(21) Appl. No.: 17/098,115

(22) Filed: Nov. 13, 2020

(51) Int. Cl. E05C 3/14; E05F 5/06

(52) U.S. Cl. CPC E05C 3/14; E05Y 2201/224; E05F 5/06

(57) ABSTRACT

A hands-free door latch allows closing the door and latching the door shut without a person using the person's hands, and further allows unlatching the latch without the person using the person's hands. In one preferred embodiment, shutting the door causes the latch to close by the force of gravity. In some embodiments, the latch can be unlatched with a person's foot. In other embodiments, the latch can be unlatched with a person's arm or elbow. The hands-free door latch allows a person to latch and unlatch a door without hands, thereby decreasing the likelihood of exposing a person's hands to germs left by someone else.

### BACKGROUND

### 1. Technical Field

This disclosure generally relates to door latches, and more specifically relates to door latches that provide hands-free operation.

### 2. Background Art

The COVID-19 pandemic has made people much more aware of what they contact with their hands. Most bathroom stalls have doors with latches that require a person to use his or her hands to lock and unlock the latch. At a time when people are trying to minimize contact with areas that are often contacted by others, these door latches create a point of exposure where germs left by one person by using the latch can easily be transferred to the hands of the next person using the latch.

### BRIEF SUMMARY

A hands-free door latch allows closing the door and latching the door shut without a person using the person's hands, and further allows unlatching the latch without the person using the person's hands. In one preferred embodiment, shutting the door causes the latch to close by the force of gravity. In some embodiments, the latch can be unlatched with a person's foot. In other embodiments, the latch can be unlatched with a person's arm or elbow. The hands-free door latch allows a person to latch and unlatch a door without hands, thereby decreasing the likelihood of exposing a person's hands to germs left by someone else.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a front view of a first embodiment of the door latch;

FIG. 2 is a perspective view of the door catch in FIG. 1;

FIG. 3 is a side view of the door catch in FIG. 1 taken along the line 3-3;

FIG. 4 is front view of the housing and pivot arm in FIG. 1;

FIG. 5 is a cross-sectional view of the housing in FIGS. 1 and 4 showing internal stops for the pivot arm;

FIG. 6 is a perspective view showing a first actuator end for the pivot arm;

FIG. 7 is a side view showing the first actuator end in FIG. 6;

FIG. 8 is a perspective view showing a second actuator end for the pivot arm;

FIG. 9 is a front view showing a third actuator end for the pivot arm;

FIG. 10 is a perspective view showing a fourth actuator end for the pivot arm;

FIG. 11 is a top view showing the fourth actuator end in FIG. 10;

FIG. 12 is a perspective view showing a fifth actuator end for the pivot arm;

FIG. 13 is a perspective view showing a sixth actuator end for the pivot arm;

FIG. 14 is a perspective view showing a seventh actuator end for the pivot arm;

FIG. 15 is a perspective view showing an eighth actuator end for the pivot arm;

FIG. 16 is a perspective view showing a ninth actuator end for the pivot arm;

FIG. 17 is a perspective view showing a tenth actuator end for the pivot arm;

FIG. 18 is a perspective view showing an eleventh actuator end for the pivot arm;

FIG. 19 is a perspective view showing a twelfth actuator end for the pivot arm;

FIG. 20 is a perspective view of a latch portion of a second embodiment of the door latch;

FIG. 21 is a perspective view of a first embodiment for the door catch for the second embodiment of the door latch;

FIG. 22 is a perspective view of a second embodiment for the door catch for the second embodiment of the door latch;

FIG. 23 is a top view of the door latch in FIG. 21 with the actuator in the unlatched position;

FIG. 24 is a top view of the door latch in FIG. 21 with the actuator in the latched position;

FIG. 25 is a top cross-sectional view of the housing in FIG. 23 when the actuator is in the latched position;

FIG. 26 is a top cross-sectional view of the housing in FIG. 24 when the actuator is in the unlatched position;

FIG. 27 is a perspective view of a latch portion of a third embodiment of the door latch;

FIG. 28 is a top view of the latch portion in FIG. 27 in the unlatched position;

FIG. 29 is a top view of the latch portion in FIG. 27 in the latched position;

FIG. 30 is a perspective view of a fourth embodiment of the door latch in a latched position;

FIG. 31 is a perspective view of the door latch in FIG. 30 in the unlatched position;

FIG. 32 is a perspective view of the latch portion shown in FIGS. 30 and 31;

FIG. 33 is a perspective view of the catch shown in FIGS. 30 and 31;

FIG. 34 is a side view of the door latch in FIG. 30 in the latched position; and

FIG. 35 is a side view of the door latch in FIG. 31 in the unlatched position.

### DETAILED DESCRIPTION

A hands-free door latch allows closing the door and latching the door shut without a person using the person's hands, and further allows unlatching the latch without the person using the person's hands. In one preferred embodiment, shutting the door causes the latch to close by the force of gravity. In some embodiments, the latch can be unlatched with a person's foot. In other embodiments, the latch can be unlatched with a person's arm or elbow. The hands-free door latch allows a person to latch and unlatch a door without hands, thereby decreasing the likelihood of exposing a person's hands to germs left by someone else.

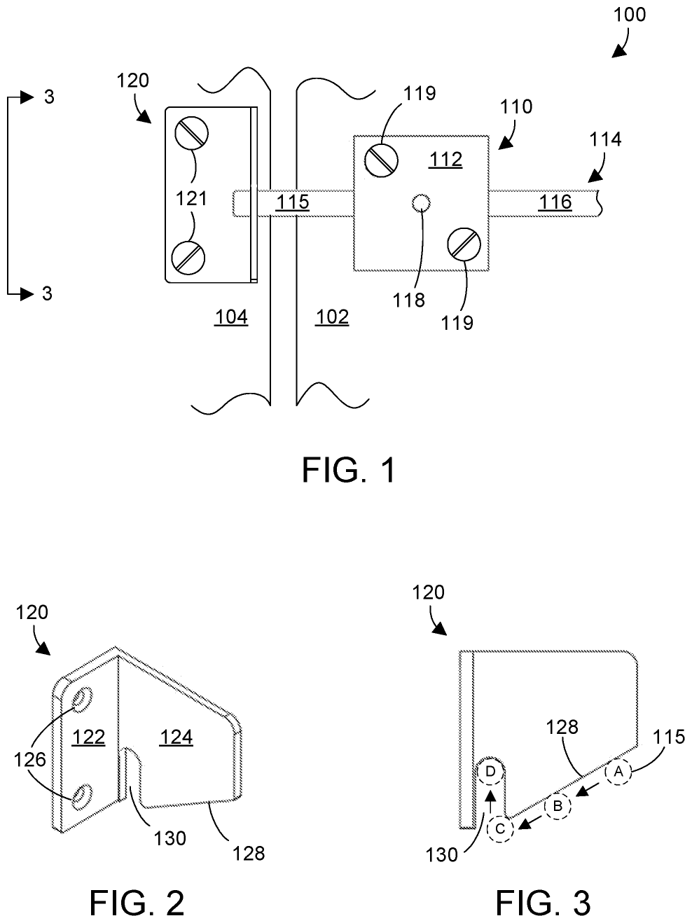

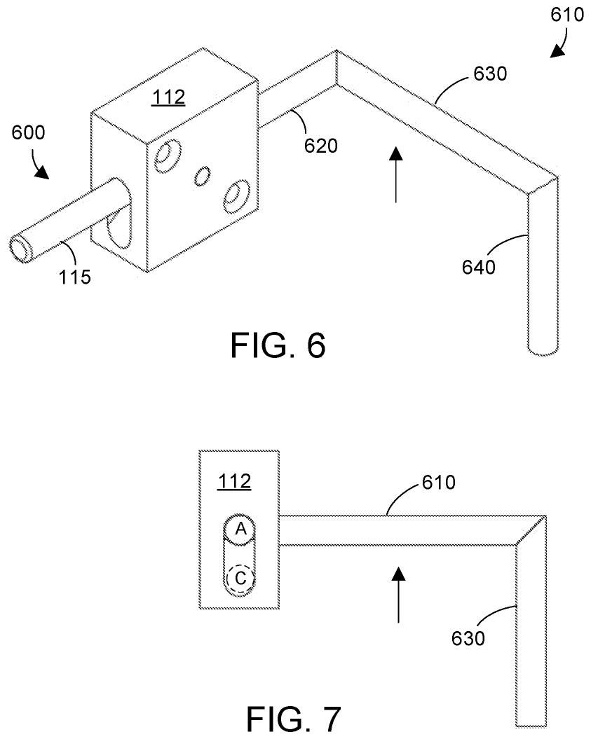

A first embodiment of the door latch in accordance with the disclosure and claims herein is shown in FIGS. 1-19. Referring to FIG. 1, a door latch 100 comprises a latch portion 110 that includes a pivot arm 114 pivotally coupled to and captivated within a housing 112, and a catch 120. The pivot arm 114 has a latch end 115 that engages the catch 120, and an actuator end 116 that a person can preferably actuate with a person's arm, elbow or foot, thereby allowing working the latch 100 without using a person's hands. Actuator end 116 is shown cut-away in FIG. 1 to represent the actuator end 116 can have any suitable configuration. Examples of suitable configurations for actuator ends 116 are shown in FIGS. 6-19 and are discussed in more detail below.

The housing 112 is preferably attached to a first mounting surface 102 using any suitable fasteners or fastening means. For the purpose of illustration, housing 112 shown in FIG. 1 is attached to first mounting surface 102 using two slot-head screws 119. The catch 120 is preferably attached to a second mounting surface 104 that is in proximity to the first mounting surface 102. The catch 120 may be attached using any suitable fasteners or fastening means, but is shown in FIG. 1 by way of illustration to be attached to mounting surface 104 using two slot-head screws 121. In the most preferred configuration, one of the mounting surfaces 102 and 104 is stationary, while the other mounting surface is movable with respect to the stationary mounting surface. For example, portion 104 could be a stationary portion of a wall or partition, while mounting surface 102 could be a door. In the alternative, mounting surface 102 could be a stationary portion of a wall or partition, while mounting surface 104 is a door. The specific example in FIG. 3 assumes the mounting surface 104 is stationary and the mounting surface 102 is a door. However, these two could be reversed as discussed above. For the examples discussed herein, it is assumed the mounting surface 104 is a stationary mounting surface such as a wall or bathroom stall partition that does not move, and the mounting surface 102 is a moving door. For this reason, item 102 in FIG. 1 as discussed herein is referred to both as a mounting surface in a general sense and a door as one specific example of a mounting surface.

A perspective view of the catch 120 is shown in FIG. 2. Catch 120 includes a first portion 122 that is placed flat against the mounting surface 104 and a second portion 124 that extends from the first portion 122. The first portion 122 includes two holes 126 for attaching the catch 120 to the portion 104 in FIG. 1 using screws 121. In the preferred implementation shown in FIGS. 1-3, the second portion 124 extends at a right angle from the first portion 122. Of course, any suitable angle or configuration could be used. The second portion 124 includes a sloped surface 128 that leads to a slot 130. The operation of the latch engaging the catch is shown in FIG. 3.

The pivot arm 114 in FIG. 1 preferably has a center of mass to the right of the pivot point 118 in the housing 112, which makes the pivot arm 114 normally in the substantially horizontal position shown in FIG. 1 under force of gravity. This means the mass of the pivot arm on the actuator end (to the right of the pivot hole) is greater than the mass of the pivot arm on the latch end (to the left of the pivot hole). We assume for the example in FIG. 3 the mounting surface 102 is a door and the mounting surface 140 is a wall or partition that does not move. FIG. 3 illustrates how the latch end 115 of the pivot arm 114 engages the catch 120 as the door is closed. We assume as the door is closed, the latch end 115 of the pivot arm 114 first contacts the slope 128 on the catch 120 at position A shown in FIG. 3. As the door is pushed shut, the latch end 115 of the pivot arm travels along the slope to position B, causing the pivot arm 114 to pivot. As the door continues to close, the latch end 115 of the pivot arm 114 travels along the slope to position C, causing the pivot arm to further pivot. Once the latch end 115 of the pivot arm 114 reaches the slot 130, the pivot arm returns to the substantially horizontal position by force of gravity, as shown at position D. The combination of the slope 128 on the catch 120 and the pivot arm that has a center of mass to the right of the pivot point 118 in FIG. 1 results in a latch portion that latches into the catch by simply shutting the door.

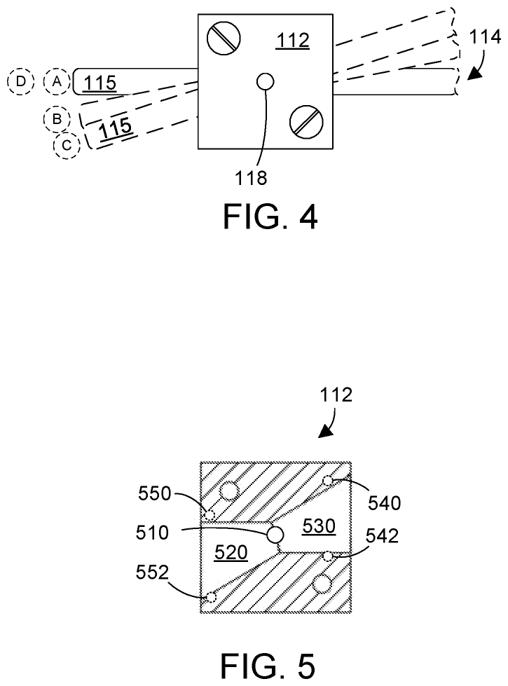

The pivoting of the pivot arm 114 within the housing 112 is shown in FIG. 4. Note the positions of the latch end 115 of the pivot arm 114 in FIG. 4 correspond to the positions shown in FIG.3. Thus, when the door is open, the latch end is in position A by force of gravity because the center of mass of the pivot arm 114 is to the right of the pivot point 118. As the door is pushed closed, the latch end 115 slides along the sloped surface 128 of the catch 120 to position B, then to position C, then when the latch end 115 reaches the slot 130 in the catch 120, the pivot arm 114 pivots by force of gravity back to position D, which is preferably the same position as position A. Note positions A and D can be different. For example, if the slot 130 were not as deep, and prevented the pivot arm from returning to position A, the latch would still function with position A being different than position D.

FIG. 5 shows a partial cross-sectional view of the housing 112 for the pivot arm 114. The housing 112 preferably includes a pin 510 onto which the pivot arm is placed by sliding a hole in the pivot arm over the pin 510. The hole in the pivot arm 114 is preferably larger than the diameter of the pivot pin 510 so the pivot arm can pivot freely without binding on the pivot pin 510. The housing 112 shown in FIG. 5 includes a first open portion 520 to the left of the pivot pin and a second open portion 530 to the right of the pivot pin. These open portions are configured to allow the pivot arm to pivot freely between the substantially horizontal positions A and D shown in FIGS. 1, 3 and 4 and other pivot positions, such as positions B and C shown in FIGS. 3 and 4. One can readily observe by comparing FIGS. 4 and 5 that the open portions 520 and 530 provide stops that constrain the movement of the pivot arm 114. The stops in housing 112 that limit the movement of the pivot arm 114 can have any suitable configuration. For example, the open portion 530 on the right side of the pivot pin could encompass the entire right half of the housing, while the open portion 520 as shown in FIG. 5 provides the needed stops for the motion of the pivot arm. In an alternative configuration, the open portion 520 on the left side of the pivot pin could encompass the entire left half of the housing, while the open 530 shown in FIG. 5 provides the needed stops for the motion of the pivot arm. In the configuration shown in FIG. 5, a solid metal block is provided for the bottom portion of housing 112, and open portions 520 and 530 are then milled into the solid block. Once the pivot arm 114 is placed onto the pivot pin 510, a top cover is placed on the housing, and when the screws are placed through the top cover and through the holes in the bottom of the housing and screwed into the door 102, the pivot arm 114 is captivated within the housing 112 and pivots only the amount permitted by one or more stops in the housing 112.

While the configuration shown in FIG. 5 includes milled open portions 520 and 540, other stops could be provided. For example, two or more pins could provide the needed stops within the housing 112 for the pivot arm 114. Pins 540, 542, 550 and 552 in FIG. 5 shown in phantom in FIG. 5 are an alternative configuration that provides the needed stops within the housing 112 to limit the pivot position of the pivot arm 114. In this configuration the entire center of the housing 112 could be open, with the pins 540, 542, 550 and 552 providing the needed stops. Note that one set of pins 540 and 542, or 550 and 552 could provide the needed stops. One skilled in the art will appreciate there are many, many ways to provide one or more stops within housing 112 to limit the pivoting of the pivot arm 114. The preferred embodiments disclosed herein expressly extend to any suitable interior configuration of the housing 112 that includes one or more stops that limit movement of the pivot arm 114 within the housing 112.

As discussed above with reference to FIG. 1, a pivot arm 114 has a latch end 115 and an actuator end 116. The actuator end 116 can have any suitable configuration. In the most preferred configurations shown by way of example herein, the center of mass of the pivot arm 114 is to the right of the pivot point 118, which results in the pivot arm resting against a stop internal to housing 112 to be in a substantially horizontal position by force of gravity. The most preferred configurations are those that allow the pivot arm to be actuated without using a person's hands. Thus, any configurations suitable for using a person's arm, elbow or foot could be used. Non-limiting examples of some suitable configurations for the actuator end 116 are shown in FIGS. 6-19. A first configuration for the pivot arm 600 shown in FIGS. 6 and 7 shows an actuator end 610 that has a first portion 620 extending from the housing 112, a second portion 630 at a right angle from the first portion 620 and in a line normal to the plane of the door 102, and a third portion 640 at a right angle from the second portion 630 and in a line normal to the plane of the floor. A person can push up on any portion of the actuator end 610 to cause the pivot arm to pivot from its rest state at position A shown in FIG. 7 to its unlatched state at position C in FIG. 7. Note these positions A and C corresponding to the positions A and C for the latch end as shown in FIGS. 3 and 4. When a latch that has a pivot arm 600 with the actuator end 610 as shown in FIGS. 6 and 7 is placed at about waist or arm height on the door 102, a person can unlatch the pivot arm 600 from the catch 120 by placing an arm or elbow under the second portion 630 or the third portion 640 and lifting, which causes the pivot arm to pivot and the latch end 115 to disengage the catch 120. The door can then be pulled opened using the person's arm or elbow, allowing unlatching the door latch and opening the door without using a person's hands.

When a latch that has a pivot arm 600 with the actuator end 610 as shown in FIGS. 6 and 7 is placed on the bottom part of the door 102, a person can unlatch the pivot arm 600 from the catch 120 by placing a foot under the second portion 630 or the third portion 640 and lifting, which causes the pivot arm to pivot and the latch end 115 to disengage the catch 120. The door can then be opened using the person's foot, allowing unlatching the door latch and opening the door without using a person's hands.

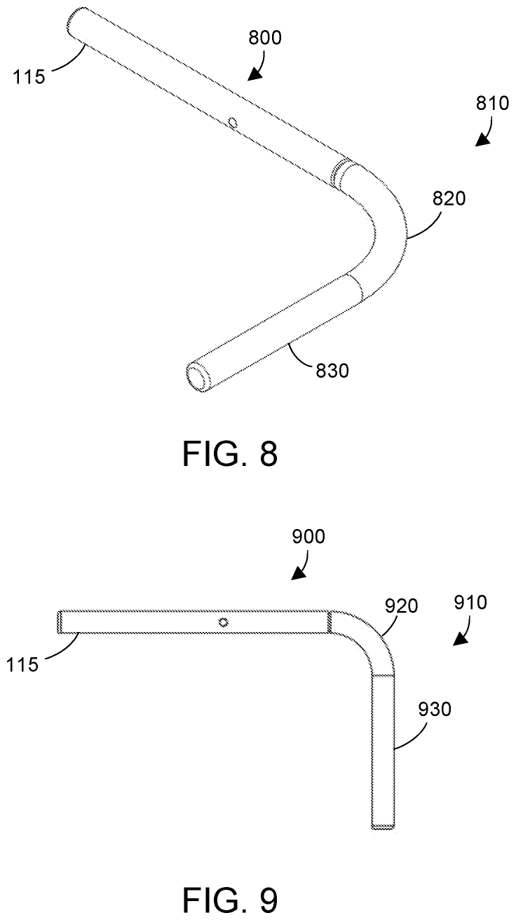

A second configuration for the pivot arm is shown in FIG. 8. Pivot arm 800 includes an actuator end 810 that includes a curved portion 820 coupled to a straight portion 830 that is in a line that is substantially normal to the plane of the door 102. When a latch that has the pivot arm 800 with actuator end 810 as shown in FIG. 8 is placed at about waist or arm height on the door 102, a person can unlatch the pivot arm 800 from the catch 120 by placing an arm or elbow under the straight portion 830 and lifting, which causes the pivot arm to pivot and the latch end 115 to disengage the catch 120. The door can then be pulled opened using the person's arm or elbow, allowing unlatching the door latch and opening the door without using a person's hands. When a latch that has the pivot arm 800 with the actuator end 810 as shown in FIG. 8 is placed on the bottom part of the door 102, a person can unlatch the pivot arm 800 from the catch 120 by placing a foot under the straight portion 830 and lifting, which causes the pivot arm to pivot and the latch end 115 to disengage the catch 120. The door can then be opened using the person's foot, allowing unlatching the door latch and opening the door without using a person's hands.

A third configuration for the pivot arm is shown in FIG. 9. Pivot arm 900 includes an actuator end 910 that includes a curved portion 920 coupled to a straight portion 930 that is in a line that is substantially parallel to the door 102 and substantially normal to the plane of the floor. When a latch that has the pivot arm 900 with actuator end 910 as shown in FIG. 9 is placed at about waist or arm height on the door 102, a person can unlatch the pivot arm 900 from the catch 120 by placing an arm or elbow under the straight portion 930 and lifting, which causes the pivot arm to pivot and the latch end 115 to disengage the catch 120. The door can then be pulled opened using the person's arm or elbow, allowing unlatching the door latch and opening the door without using a person's hands. When a latch that has the pivot arm 900 with the actuator end 910 as shown in FIG. 9 is placed on the bottom part of the door 102, a person can unlatch the pivot arm 900 from the catch 120 by placing a foot under the straight portion 930 and lifting, which causes the pivot arm to pivot and the latch end 115 to disengage the catch 120. The door can then be opened using the person's foot, allowing unlatching the door latch and opening the door without using a person's hands.

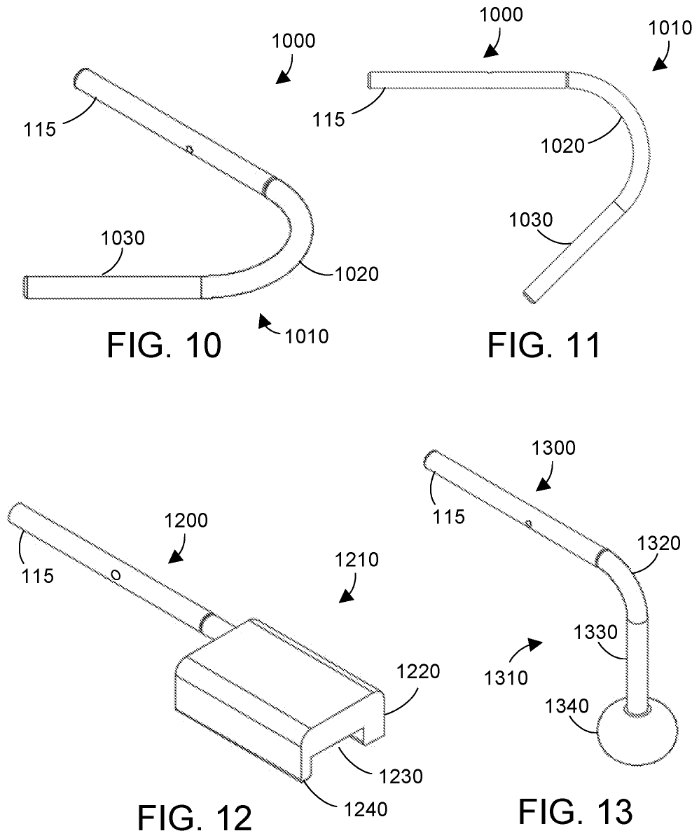

A fourth configuration for the pivot arm is shown in FIGS. 10 and 11. Pivot arm 1000 shown in FIGS. 10 and 11 shows an actuator end 1010 that has a curved portion 1020 and a straight portion 1030 extending from the curved portion 1020. When a latch that has a pivot arm 1000 with the actuator end 1010 as shown in FIGS. 10 and 11 is placed at about waist or arm height on the door 102, a person can unlatch the pivot arm 1000 from the catch 120 by placing an arm or elbow under the curved portion 1020 and/or the straight portion 1030 and lifting, which causes the pivot arm to pivot and the latch end 115 to disengage the catch 120. The door can then be pulled opened using the person's arm or elbow, allowing unlatching the door latch and opening the door without using a person's hands. When a latch that has a pivot arm 1000 with the actuator end 1010 as shown in FIGS. 10 and 11 is placed on the bottom part of the door 102, a person can unlatch the pivot arm 1000 from the catch 120 by placing a foot under the curved portion 1020 and/or the straight portion 1030 and lifting, which causes the pivot arm 1000 to pivot and the latch end 115 to disengage the catch 120. The door can then be opened using the person's foot, allowing unlatching the door latch and opening the door without using a person's hands.

A fifth configuration for the pivot arm is shown in FIG. 12. Pivot arm 1200 includes an actuator end 1210 that includes a block member 1220 that has a lower recess 1230 that provides a lip 1240. Lip 1240 is an example of a raised member that allows a person to actuate the actuator arm 1210 more easily using an arm, elbow or foot. When a latch that has the pivot arm 1200 with actuator end 1210 as shown in FIG. 12 is placed at about waist or arm height on the door 102, a person can unlatch the pivot arm 1200 from the catch 120 by placing an arm or elbow under the block portion 1220 and lifting, which causes the pivot arm to pivot and the latch end 115 to disengage the catch 120. The door can then be pulled opened using the person's arm or elbow, with the lip 1240 engaging the person's arm or elbow, allowing unlatching the door latch and opening the door without using a person's hands. When a latch that has the pivot arm 1200 with the actuator end 1210 as shown in FIG. 12 is placed on the bottom part of the door 102, a person can unlatch the pivot arm 1200 from the catch 120 by placing a foot under the block portion 1220 and lifting, which causes the pivot arm to pivot and the latch end 115 to disengage the catch 120. The door can then be opened using the person's foot, with the toe area of the person's foot going into the recess 1230 and engaging the lip 1240, allowing unlatching the door latch and opening the door without using a person's hands.

A sixth configuration for the pivot arm is shown in FIG. 13. Pivot arm 1300 includes an actuator end 1310 that includes a curved portion 1320 coupled to a straight portion 1330 that is in a line that is substantially parallel to the door 102 and substantially normal to the plane of the floor. The straight portion 1330 is attached to a ball 1340. When a latch that has the pivot arm 1300 with actuator end 1310 as shown in FIG. 13 is placed at about waist or arm height on the door 102, a person can unlatch the pivot arm 1300 from the catch 120 by placing an arm or elbow under the ball 1340 and lifting, which causes the pivot arm to pivot and the latch end 115 to disengage the catch 120. The door can then be pulled opened using the person's arm or elbow, allowing unlatching the door latch and opening the door without using a person's hands. When a latch that has the pivot arm 1300 with the actuator end 1310 as shown in FIG. 13 is placed on the bottom part of the door 102, a person can unlatch the pivot arm 1300 from the catch 120 by placing a foot under the ball 1340 and lifting, which causes the pivot arm to pivot and the latch end 115 to disengage the catch 120. The door can then be opened using the person's foot, allowing unlatching the door latch and opening the door without using a person's hands. In one specific implementation, the ball 1340 is rigid, such as metal or plastic. In an alternative implementation, the ball 1340 is soft, such as rubber.

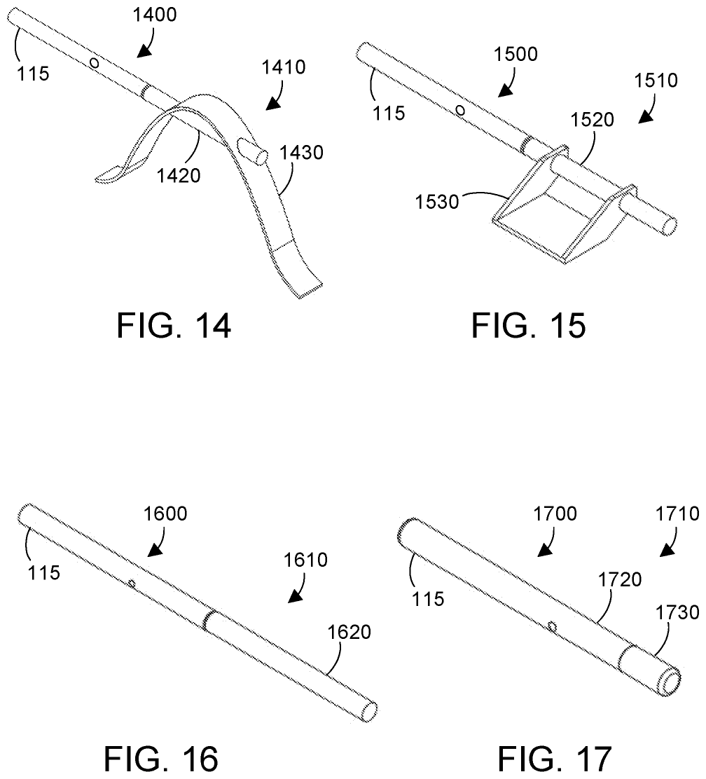

A seventh configuration for the pivot arm is shown in FIG. 14. Pivot arm 1400 includes an actuator end 1410 that includes a curved portion 1430 coupled to a straight portion 1420. When a latch that has the pivot arm 1400 with actuator end 1410 as shown in FIG. 14 is placed at about waist or arm height on the door 102, a person can unlatch the pivot arm 1400 from the catch 120 by placing an arm or elbow under the straight portion 1420 and/or curved portion 1430 and lifting, which causes the pivot arm to pivot and the latch end 115 to disengage the catch 120. The door can then be pulled opened using the person's arm or elbow, allowing unlatching the door latch and opening the door without using a person's hands. When a latch that has the pivot arm 1400 with the actuator end 1410 as shown in FIG. 14 is placed on the bottom part of the door 102, a person can unlatch the pivot arm 1400 from the catch 120 by placing a foot under the straight portion 1420 and/or curved portion 1430 and lifting, which causes the pivot arm to pivot and the latch end 115 to disengage the catch 120. The door can then be opened using the person's foot, allowing unlatching the door latch and opening the door without using a person's hands.

An eighth configuration for the pivot arm is shown in FIG. 15. Pivot arm 1500 includes an actuator end 1510 that includes a straight portion 1520 and an extended platform 1530 coupled to a straight portion 1520. When a latch that has the pivot arm 1500 with actuator end 1510 as shown in FIG. 15 is placed at about waist or arm height on the door 102, a person can unlatch the pivot arm 1500 from the catch 120 by placing an arm or elbow under the platform 1530 and lifting, which causes the pivot arm to pivot and the latch end 115 to disengage the catch 120. The door can then be pulled opened using the person's arm or elbow, allowing unlatching the door latch and opening the door without using a person's hands. Because the platform 1530 extends away from the door 102 and provides a greater surface area than the straight portion 1520, it is easier for a person to lift the pivot arm 1500 using the platform 1530. When a latch that has the pivot arm 1500 with the actuator end 1510 as shown in FIG. 15 is placed on the bottom part of the door 102, a person can unlatch the pivot arm 1500 from the catch 120 by placing a foot under the platform 1530 and lifting, which causes the pivot arm to pivot and the latch end 115 to disengage the catch 120. The door can then be opened using the person's foot, allowing unlatching the door latch and opening the door without using a person's hands. Note that platform 1530 could include one or more raised members facing downward that allow a person to grip the platform 1530 more easily using an arm, elbow or foot.

A ninth configuration for the pivot arm is shown in FIG. 16. Pivot arm 1600 includes an actuator end 1610 that includes a straight portion 1620. When a latch that has the pivot arm 1600 with actuator end 1610 as shown in FIG. 16 is placed at about waist or arm height on the door 102, a person can unlatch the pivot arm 1600 from the catch 120 by placing an arm or elbow under the straight portion 1620 and lifting, which causes the pivot arm to pivot and the latch end 115 to disengage the catch 120. The door can then be pulled opened using the person's arm or elbow, allowing unlatching the door latch and opening the door without using a person's hands. When a latch that has the pivot arm 1600 with the actuator end 1610 as shown in FIG. 16 is placed on the bottom part of the door 102, a person can unlatch the pivot arm 1600 from the catch 120 by placing a foot under the flat portion 1620 and lifting, which causes the pivot arm to pivot and the latch end 115 to disengage the catch 120. The door can then be opened using the person's foot, allowing unlatching the door latch and opening the door without using a person's hands.

A tenth configuration for the pivot arm is shown in FIG. 17. Pivot arm 1700 includes an actuator end 1710 that includes a straight portion 1720 coupled to a weighted end 1730. In order to have the center of mass of the pivot arm 1700 to the right of the hole that is the pivot point for the pivot arm, the weighted end 1730 is preferably made of a material that has more mass than the rest of the pivot arm 1700. For example, the pivot arm 1700 and its straight portion 1720 could be made of lightweight aluminum, while the weighed end 1730 could be made of steel. When a latch that has the pivot arm 1700 with actuator end 1710 as shown in FIG. 17 is placed at about waist or arm height on the door 102, a person can unlatch the pivot arm 1700 from the catch 120 by placing an arm or elbow under the straight portion 1720 and/or weighted end 1730 and lifting, which causes the pivot arm to pivot and the latch end 115 to disengage the catch 120. The door can then be pulled opened using the person's arm or elbow, allowing unlatching the door latch and opening the door without using a person's hands. When a latch that has the pivot arm 1700 with the actuator end 1710 as shown in FIG. 17 is placed on the bottom part of the door 102, a person can unlatch the pivot arm 1700 from the catch 120 by placing a foot under the straight portion 1720 and/or weighted end 1730 and lifting, which causes the pivot arm to pivot and the latch end 115 to disengage the catch 120. The door can then be opened using the person's foot, allowing unlatching the door latch and opening the door without using a person's hands.

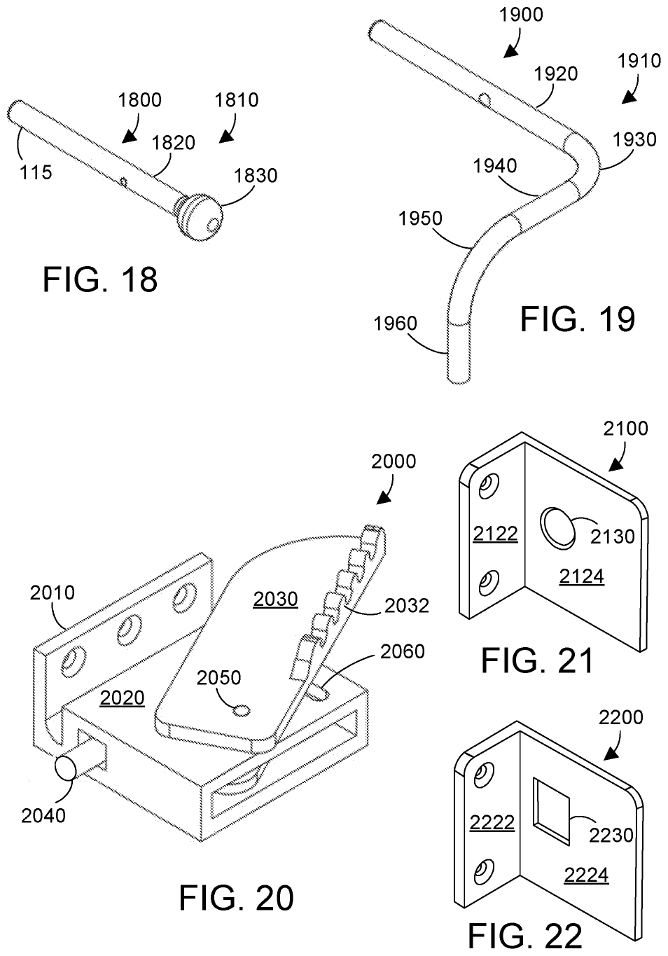

An eleventh configuration for the pivot arm is shown in FIG. 18. Pivot arm 1800 includes an actuator end 1810 that includes a straight portion 1820 coupled to a ball 1830. The ball can be made of any suitable rigid or flexible material. When a latch that has the pivot arm 1800 with actuator end 1810 as shown in FIG. 18 is placed at about waist or arm height on the door 102, a person can unlatch the pivot arm 1800 from the catch 120 by placing an arm or elbow under the straight portion 1820 and/or ball 1830 and lifting, which causes the pivot arm to pivot and the latch end 115 to disengage the catch 120. The door can then be pulled opened using the person's arm or elbow, allowing unlatching the door latch and opening the door without using a person's hands. When a latch that has the pivot arm 1800 with the actuator end 1810 as shown in FIG. 18 is placed on the bottom part of the door 102, a person can unlatch the pivot arm 1800 from the catch 120 by placing a foot under the straight portion 1820 and/or ball 1830 and lifting, which causes the pivot arm to pivot and the latch end 115 to disengage the catch 120. The door can then be opened using the person's foot, allowing unlatching the door latch and opening the door without using a person's hands.

A twelfth configuration for the pivot arm is shown in FIG. 19. Pivot arm 1900 includes an actuator end 1910 that includes a straight portion 1920 coupled to a first curved portion 1930 that turns away from the door 102, which is coupled to a straight portion 1940, which is coupled to a second curved portion 1950 that turns towards the floor, which is coupled to a straight portion 1960. When a latch that has the pivot arm 1900 with actuator end 1910 as shown in FIG. 19 is placed at about waist or arm height on the door 102, a person can unlatch the pivot arm 1900 from the catch 120 by placing an arm or elbow under any of the straight portion 1920, the curved portion 1930, the straight portion 1940, the curved portion 1950, or the straight portion 1960 and lifting, which causes the pivot arm to pivot and the latch end 115 to disengage the catch 120. The door can then be pulled opened using the person's arm or elbow, allowing unlatching the door latch and opening the door without using a person's hands. When a latch that has the pivot arm 1900 with the actuator end 1910 as shown in FIG. 19 is placed on the bottom part of the door 102, a person can unlatch the pivot arm 1900 from the catch 120 by placing a foot any of the straight portion 1920, the curved portion 1930, the straight portion 1940, the curved portion 1950, or the straight portion 1960 and lifting, which causes the pivot arm to pivot and the latch end 115 to disengage the catch 120. The door can then be opened using the person's foot, allowing unlatching the door latch and opening the door without using a person's hands.

All of the examples above assume the latch portion 110 has a pivot arm with a center of mass to the right of the pivot point, along with a stop in the housing 112 that stops the travel of the pivot arm at a point that is substantially horizontal. When the door 102 is open, the door may be latched by simply pushing the door closed with an arm, elbow or foot, which will cause the latch end 115 of the pivot arm to slide along the slope 128 as shown in FIG. 3 until the latch end 115 encounters the slot 130, which will cause the pivot arm to return to the substantially horizontal position, thereby engaging the slot and latching to door closed. A person may then unlatch the latch from the catch by lifting on the actuator end of the pivot arm and pulling the actuator arm, resulting in the latch end 115 of the pivot arm disengaging from the catch 120 and allowing the door to be pulled away from the catch.

The various examples of actuator arms shown in FIGS. 6-19 are shown by way of example, and are not limiting. The disclosure and claims herein extend to any suitable configuration for an actuator arm for a pivot arm that may be actuated by a person's arm, elbow or foot.

A second embodiment of a hands-free door latch is shown in FIGS. 20-26. In this embodiment, a latch portion 2000 is placed on a mounting surface such as 102 in FIG. 1, and the catch is mounted on a mounting surface such as 104 in FIG. 1. The latch portion 2000 includes a movable actuator 2030 that controls a plunger 2040 that can be extended through the catch or retracted from the catch according to the movement of the actuator 2030. The actuator 2030 may include one or more raised members 2032 that allow more easily gripping the actuator with a person's arm, elbow or foot. Examples of suitable catches are shown in FIGS. 21 and 22. Catch 2100 in FIG. 21 includes a first portion 2122 that is placed flat against the mounting surface 104 and a second portion 2124 that extends from the first portion 2122. The first portion 2122 includes two holes for attaching the catch 2100 to the mounting surface 104 using screws. In the preferred implementation shown in FIG. 21, the second portion 2124 extends at a right angle from the first portion 2122. Of course, any suitable angle or configuration could be used. The second portion 2124 includes an opening or hole 2130 through which the plunger 2040 passes when the latch portion 2000 engages the catch 2100. The hole 2130 can have any suitable shape. For example, hole 2130 in FIG. 21 is shown as a circular hole. In an alternative embodiment for the catch shown in FIG. 22, catch 2200 includes a first portion 2222 and a second portion 2224 that has a square hole 2230. Note the cross section the plunger 2040 can be any suitable shape. In addition, the cross-section of the plunger need not match the shape of the hole in the catch. Thus, a plunger 2040 that has a circular cross-section as shown in FIG. 20 can be used with a catch 2200 shown in FIG. 22 that has a square hole 2230. The preferred embodiments expressly extend to any suitable cross section for the plunger 2040 and any suitable shape for the hole in the catch.

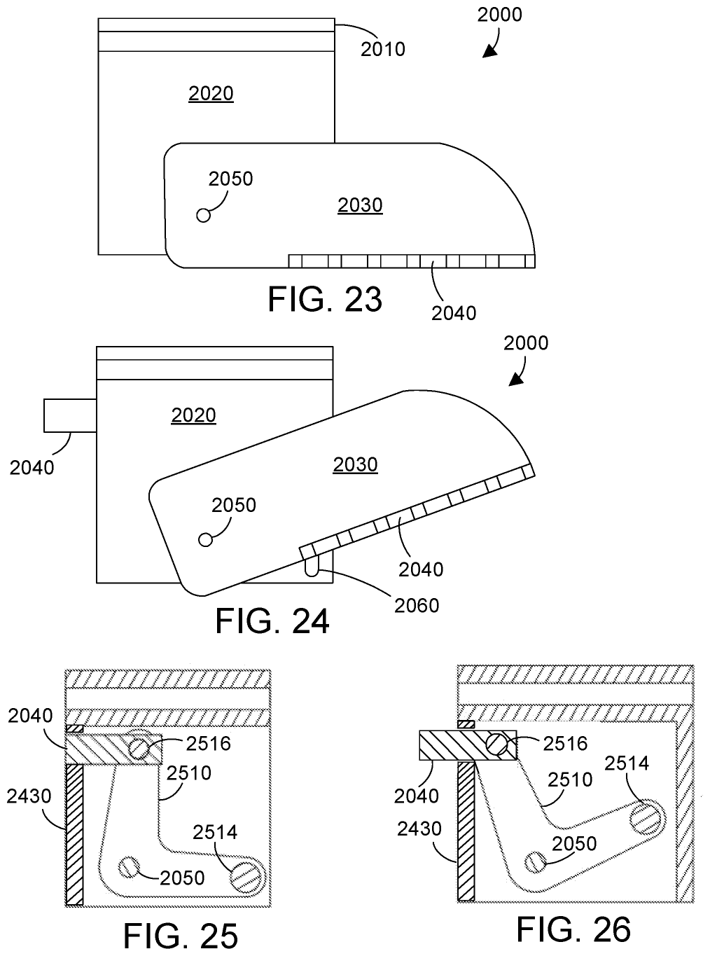

The latch portion 2000 shown in FIG. 20 has the actuator 2030 attached to an internal piece within the housing 2020 at two points. The first is at pivot point 2050, and the second is through a slot 2060. This allows the actuator to pivot about the pivot point 2050. The operation of the latch portion 2000 is best understood with reference to FIGS. 23-26. With the actuator 2030 in the position shown in FIG. 23, the plunger 2040 is retracted within the housing 2020. The cross-sectional view in FIG. 25 illustrates an internal L-shaped member 2510 that pivots about the pivot point 2050. A first end of the L-shaped member 2516 is coupled to the plunger 2040 while the second end 2514 is coupled to the actuator 2030 through the slot 2060 shown in FIGS. 20 and 24. The combination of the fixed pivot point at 2050 and the movement of the actuator 2030 in the slot 2060 creates a substantially linear movement of the plunger 2040 out of the housing and back into the housing when retracted. With the actuator 2030 in the unlatched position shown in FIG. 23, the internal cross-section is shown in FIG. 25. When a person pushes on the actuator 2030, the actuator moves from the unlatched position shown in FIG. 23 to the latched position shown in FIG. 24. The internal cross-section is shown in FIG. 26. The second end 2514 of the L-shaped member 2510 has moved along the slot 2060, causing the first end 2516 to push the plunger 2040 outside of the housing 2020 and into the catch. Note the slot 2060 can be straight and having a width that allows the connection between the actuator 2030 and the second end 2514 to travel in a slightly arcuate path, or the slot 2060 could be narrower with an arcuate shape that matches the arcuate travel of the second end 2514.

One can easily see from FIGS. 23-26 the operation of the latch portion 2000. We assume the latch portion 2000 is mounted on a movable door, while the corresponding catch (see FIGS. 21 and 22 for examples) is on a fixed wall or partition near the door. With the actuator 2030 of the latch portion 2000 as shown in FIGS. 23 and 25, the door is closed, which aligns the plunger 2040 with the hole in the catch. Once the door is closed, a person moves the actuator 2030 with an arm, elbow or foot to the position shown in FIGS. 24 and 26, which causes the plunger 2040 to extend from the housing 2020 through the hole in the catch, thereby latching the door closed. The door may be unlatched by a person moving the actuator 2030 from the position shown in FIGS. 24 and 26 to the position shown in FIGS. 23 and 25 using an arm, elbow or foot, which retracts the plunger 2040 back into the housing 2020, which disengages the plunger 2040 from the catch and allows the door to swing open as the person continues to pull on the actuator 2030.

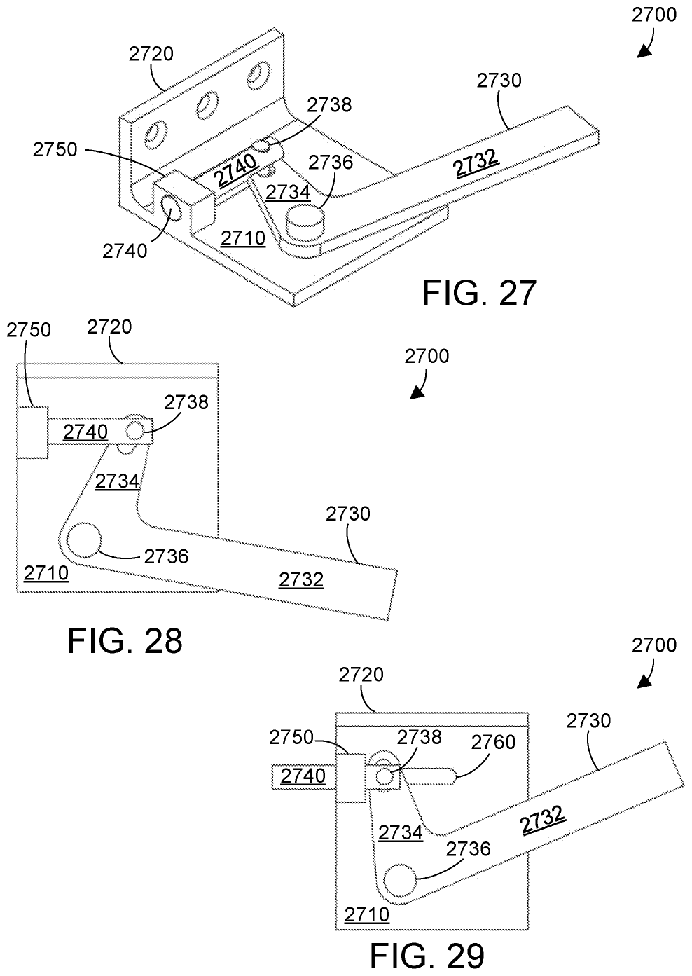

A third embodiment for the latch portion of a hands-free door latch is shown in FIGS. 27-29. Latch portion 2700 may be used with catches such as those shown in FIGS. 21 and 22, or with any other suitable catch capable of retaining plunger 2740 when extended. The latch includes an L-shaped actuator 2730 that has a first end 2732 that can be moved by a person, a pivot point 2736, and a second end 2734 coupled to a plunger 2740 via a pin 2738 or other fastener. When the actuator 2730 is in the position shown in FIGS. 27 and 28, the plunger 2740 is retracted within a portion 2750 of the housing 2710. When the actuator 2730 is pressed towards the door to the position shown in FIG. 29, the actuator 2730 pivots about the pivot point 2736, which causes the second end 2734 to extend the plunger 2730 from the portion 2750 of the housing into the catch. Because of the combination of the portion 2750 of the housing 2710 and a slot in the second end 2734 of the actuator 2730, the movement of the plunger 2740 is substantially linear. When the person moves the actuator 2730 from the position shown in FIG. 29 to the position shown in FIGS. 27 and 28, the plunger 2740 retracts and disengages from the catch, allowing continued pulling force on actuator 2730 to open the door. As with the first two embodiments, the latch portion 2700 can be mounted at any suitable height on the door, allowing the latch portion 2700 to be actuated using a person's arm, elbow or foot.

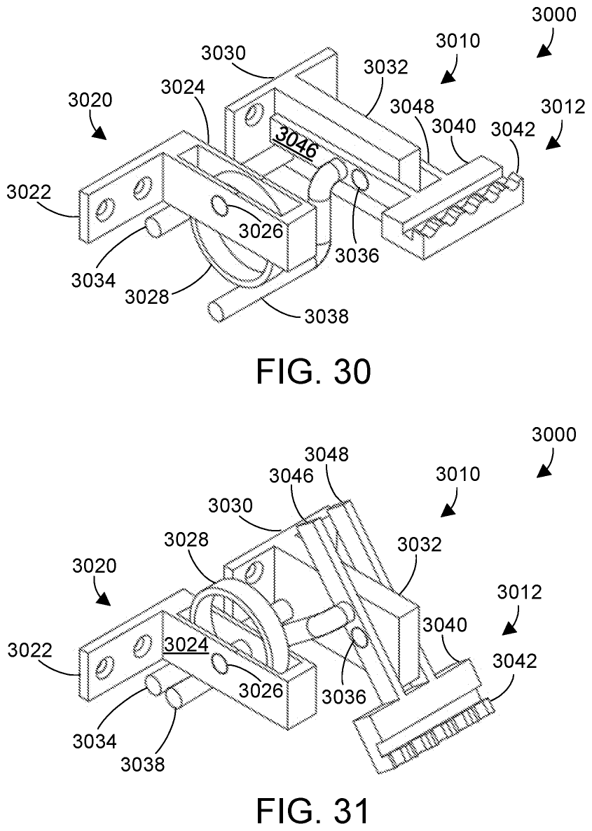

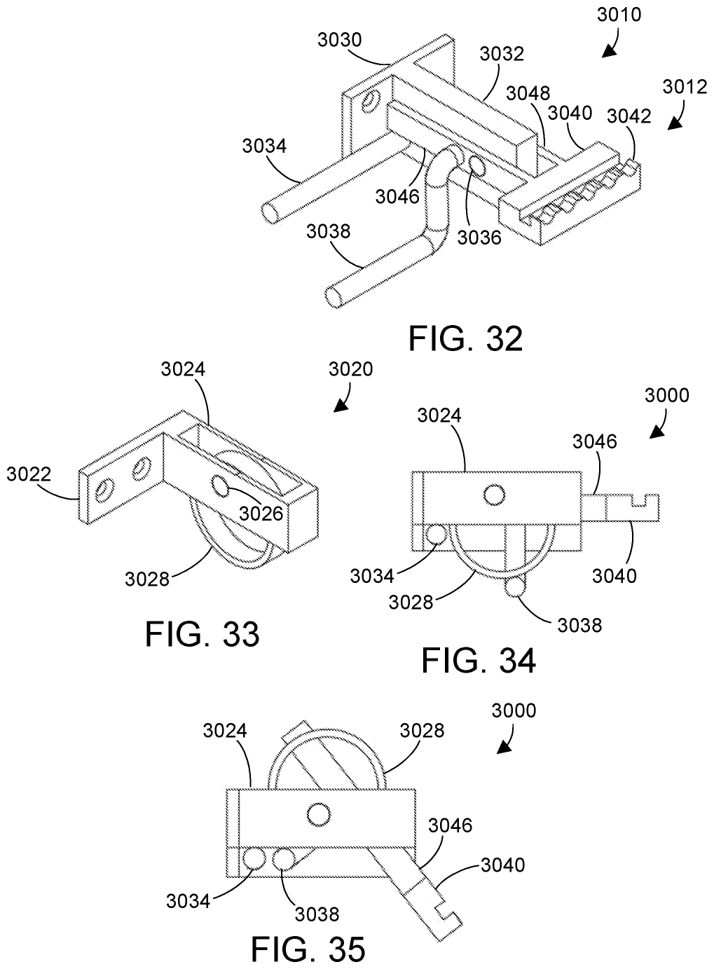

A fourth embodiment of a hands-free latch is shown in FIGS. 30-33. The latch 3000 includes a latch portion 3010 and a catch 3020. The latch portion 3010 includes a base portion 3030 that attaches to a mounting surface such as a door, with a member 3032 that preferably extends perpendicularly from the base portion 3030. A fixed stop member 3034 extends from the member 3032 as shown in FIGS. 30 and 32. An actuator 3012 includes an outer portion 3040 and may optionally include one or more raised portions 3042 that provide a better grip for a person to move the actuator 3012. The actuator includes two parallel arms 3046 and 3048 extending from the outer portion 3040 that are attached to the member 3032 at a pivot point 3036 so the actuator 3012 can pivot with respect to the member 3032. A ring contacting member 3038 preferably has a configuration shown in FIGS. 30-32, and is fixedly coupled to the arm 3046 so that pivoting the actuator 3012 results in arcuate movement of the arm 3038 from the latched position shown in FIG. 30 to the unlatched position shown in FIG. 31. In the most preferred implementation, the actuator 3012 has a center of mass to the left of the pivot point 3036 shown in FIGS. 30-32, which results in the actuator being in the position shown in FIGS. 30 and 32 by force of gravity.

The catch 3020 includes a base portion 3022 for attaching to a fixed wall or partition in proximity to the door on which the latch portion 3010 is mounted. A slot member 3024 extends perpendicularly from the base portion 3022. Within the slot member 3024 is a pin 3026 that captivates a ring 3028 that is narrower than the width of the slot, allowing the ring to move up, down and sideways within the slot. The combination of the fixed stop member 3024, the ring 3028, and the arm 3038 allow the latch 3000 to open and close. With the actuator in the position shown in FIGS. 30, 32 and 34 when the door on which the latch portion 3010 is open, as the door is closed, the fixed stop member 3034 contacts the ring 3028 and pushes the ring 3028 up in the slot so the fixed stop member 3034 can continue past the ring 3028, at which point the ring drops down as shown in FIGS. 30, 33 and 34 to engage the fixed stop and latch the latch portion 3010 to the catch 3020. This latches the door shut. To open the door, a person moves the actuator 3012 to the position shown in FIGS. 31 and 35, which moves the ring 3028 up within the slot. The person continues pulling the actuator 3012 until the latch portion 3010 is clear from the catch 3020, thereby unlatching the latch. As with the first three embodiments, the latch of the fourth embodiment may be mounted in any suitable location or position on a door that allows a person to open and close the door without using the person's hands.

The latches, latch portions and catches disclosed herein can be made of any suitable materials. In one specific implementation, these are made of metal. In another implementation, these could be made of composite materials. In yet another implementation, these could be made of plastic or other synthetic materials. In addition, these may be made with combinations of different materials. Thus, the latch portion could be metal and the catch portion could be plastic. The actuator could be made of metal while the rest of the catch portion could be made of plastic. The disclosure and claims herein expressly extend to any suitable materials or combinations of materials for the latch, latch portions and catches.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. A door latch comprising:
a catch fixedly coupled to a wall portion, the catch comprising a sloped surface that leads to a recess;
a latch portion fixedly coupled to a door that is adjacent to the wall portion and adjacent to the catch when the door is closed, wherein the latch comprises:
a housing fixedly coupled to a door; and
a pivot arm pivotally coupled to the housing, the pivot arm comprising a latch end and an actuator end opposite the latch end, wherein the pivot arm is in a first position under force of gravity when the door is open and as the door closes the pivot arm pivots by the latch end sliding along the sloped surface of the catch until the latch end engages the recess in the catch, wherein a person disengages the latch end from the recess by actuating the actuator end to pivot the latch end out of the recess.

2. The door latch of claim 1 wherein the housing comprises at least one stop that limits range of the pivot arm pivoting.

3. The door latch of claim 1 wherein the sloped surface of the catch faces down.

4. The door latch of claim 1 wherein the recess of the catch faces down.

5. The door latch of claim 1 wherein the pivot arm returns to the first position by force of gravity when the latch end is in the recess of the catch.

6. The door latch of claim 1 wherein mass of the pivot arm on the actuator end is greater than mass of the pivot arm on the latch end such that under force of gravity the pivot arm is in the first position.

7. The door latch of claim 1 wherein the actuator end of the pivot arm comprises a member that extends away from the door.

8. The door latch of claim 1 wherein the actuator end of the pivot arm comprises a member that extends towards a floor below the door.

9. The door latch of claim 1 wherein the actuator end of the pivot arm comprises a ball.

10. The door latch of claim 1 wherein the actuator end of the pivot arm comprises at least one raised member that provides a grip for a person to engage the pivot arm with an arm, elbow or foot.

11. A door latch comprising:
a catch fixedly coupled to a wall portion, the catch comprising a sloped surface that faces down that leads to a recess that faces down;
a latch portion fixedly coupled to a door that is adjacent to the wall portion and adjacent to the catch when the door is closed, wherein the latch comprises:
a housing fixedly coupled to a door;
a pivot arm pivotally coupled to the housing, the pivot arm comprising a latch end and an actuator end opposite the latch end, wherein mass of the pivot arm on the actuator end is greater than mass of the pivot arm on the latch end such that under force of gravity the pivot arm is in a first position, wherein the pivot arm is in the first position under force of gravity when the door is open and as the door closes the pivot arm pivots by the latch end sliding along the sloped surface of the catch until the latch end engages the recess in the catch, wherein a person disengages the latch end from the recess by actuating the actuator end to pivot the latch end out of the recess.

12. The door latch of claim 11 wherein the actuator end of the pivot arm comprises a member that extends away from the door.

13. The door latch of claim 11 wherein the actuator end of the pivot arm comprises a member that extends towards a floor below the door.

14. The door latch of claim 11 wherein the actuator end of the pivot arm comprises a ball.

15. The door latch of claim 11 wherein the actuator end of the pivot arm comprises at least one raised member that provides a grip for a person to engage the pivot arm with an arm, elbow or foot.

16. A door latch comprising:
a housing fixedly coupled to a door;
a pivot arm pivotally coupled to the housing, the pivot arm comprising an actuator portion and a plunger portion;
a plunger coupled to the plunger portion of the pivot arm such that the plunger is retracted within the housing when the actuator portion of the pivot arm is in a first position and is extended out of the housing when the actuator portion of the pivot arm is in a second position; and
a catch on a wall portion adjacent the door, the catch comprising an opening that receives the extended plunger when the actuator portion of the pivot arm is in the second position.

17. The door latch of claim 16 wherein when the actuator portion of the pivot arm is moved from the second position to the first position, the plunger retracts into the housing, thereby disengaging from the catch.

18. The door latch of claim 16 wherein the plunger has a substantially linear motion as the plunger moves when the pivot arm changes from the first position to the second position and when the pivot arm changes from the second position to the first position.

19. The door latch of claim 16 wherein the actuator portion can be moved by a person from the first position to the second position without the person using a hand.

20. The door latch of claim 16 wherein the actuator portion can be moved by a person from the second position to the first position without the person using a hand.
